(19) United States
(12) Patent Application Publication
(10) Pub. No.: US 2026/0091978 A1
(43) Pub. Date: Apr. 2, 2026

(54) METHOD FOR PREPARING GRAPHENE FILM WITH MICROMETER GROOVE ARRAY AND TRIANGULAR CROSS-SECTION

(71) Applicant: GUANGDONG UNIVERSITY OF TECHNOLOGY, Guangzhou (CN)

(72) Inventors: Huilong LIU, Guangzhou (CN); Yun CHEN, Guangzhou (CN); Xin CHEN, Guangzhou (CN); Zhiwen XIAO, Guangzhou (CN); Renji CHEN, Guangzhou (CN); Litian GAN, Guangzhou (CN); Xun CHEN, Guangzhou (CN); Ching-Ping WONG, Guangzhou (CN)

(73) Assignee: GUANGDONG UNIVERSITY OF TECHNOLOGY, Guangzhou (CN)

(21) Appl. No.: 19/413,613

(22) Filed: Dec. 9, 2025

(30) Foreign Application Priority Data
Mar. 17, 2025 (CN) 202510313013.2

(51) Int. Cl. C01B 32/184

(52) U.S. Cl. CPC C01B 32/184; C01P 2004/03

(57) ABSTRACT

A method for preparing a graphene film with a micrometer groove array and a triangular cross-section includes the following steps: A, subjecting a flexible sheet material to a pre-treatment, and obtaining a flexible sheet substrate; B, coating a carbon precursor material onto the flexible sheet substrate according to a required thickness of a solid carbon precursor, and conducting curing to obtain a flexible composite film loaded with the solid carbon precursor; where the carbon precursor material has a triazine ring network cross-linking structure; and C, adjusting laser parameters, and conducting direct-writing scanning on a surface of the solid carbon precursor with laser, followed by cleaning and drying to obtain the graphene film with a micrometer groove array and a triangular cross-section. The method solves the problems of current traditional processing techniques, which struggle to meet the high precision and three-dimensional requirements of a micro-scale/nano-scale structure of graphene films.

### CROSS-REFERENCE TO RELATED APPLICATIONS

This application claims priority to Chinese Patent Application No. 202510313013.2 with a filing date of Mar. 17, 2025. The content of the aforementioned application, including any intervening amendments thereto, is incorporated herein by reference.

### TECHNICAL FIELD

The present disclosure relates to the technical field of graphene film processing, in particular to a method for preparing a graphene film with a micrometer groove array and a triangular cross-section.

### BACKGROUND

Graphene materials possess excellent mechanical, optical, and electrochemical properties, and have significant application values across various fields such as electronic information, energy, and materials.

In the field of electronic devices, as electronic equipment continuously evolves towards miniaturization and high performance, higher demands are placed on the conductivity, stability, and specific surface area of electrode materials. Consequently, the demand is also increasing for graphene films that can provide a higher effective specific surface area and possess a periodic array structure.

Currently, preparation techniques for graphene films include chemical vapor deposition (CVD), liquid-phase exfoliation, and chemical reduction. However, groove arrays need to be formed at the micro-scale/nano-scale level to realize graphene films with a higher effective specific surface area and periodic array structures. Traditional processing techniques such as the CVD, liquid-phase exfoliation, and chemical reduction face challenges in controlling graphene quality, involve high costs, and have relatively complex processes. Therefore, these methods cannot meet the requirements for high precision and three-dimensional structuring of graphene micro-scale/nano-scale architectures.

Furthermore, based on the realization of groove arrays at the micro-scale/nano-scale level, further restricting a cross-section of the graphene film to be triangular provides regular longitudinal channels. This structure can effectively disperse external stress, reduce stress concentration, and exhibit excellent durability under cyclic loading, maintaining the high mechanical stability of graphene. Preparing the aforementioned graphene film with a micrometer groove array and a triangular cross-section typically requires templates and lithography methods. This approach involves complex fabrication. Moreover, if structural adjustments are needed, the templates must be re-prepared, resulting in low controllability, difficulties in structural design, and a complicated process.

### SUMMARY OF PRESENT INVENTION

To address the aforementioned shortcomings, an objective of the present disclosure is to propose a method for preparing a graphene film with a micrometer groove array and a triangular cross-section. The preparing method solves the problems of current traditional processing techniques, which struggle to meet the high precision and three-dimensional requirements of a micro-scale/nano-scale structure of graphene films, involve complex processes, and present challenges in quality control and low controllability.

In order to achieve the above objective, the present disclosure adopts the following technical solutions:

The present disclosure provides a method for preparing a graphene film with a micrometer groove array and a triangular cross-section, including the following steps:
A, subjecting a flexible sheet material to a pre-treatment to obtain a flexible sheet substrate;
B, coating a carbon precursor material onto the flexible sheet substrate according to a required thickness of a solid carbon precursor, and conducting curing to obtain a flexible composite film loaded with the solid carbon precursor; where
the carbon precursor material has a triazine ring network cross-linking structure; and
C, adjusting laser parameters, and conducting direct-writing scanning on a surface of the solid carbon precursor with laser, followed by cleaning and drying to obtain the graphene film with a micrometer groove array and a triangular cross-section.

Preferably, in the step C, the laser parameters include: a wavelength of 200 nm to 360 nm, a pulse width less than 12 ps, a laser power of 3 W to 5 W, and conducting unidirectional overlapping linear scanning with laser in a defocusing manner; and the unidirectional overlapping linear scanning with laser has a scanning spacing of 20% to 60% of a spot size, a defocusing amount of −2 mm to −8 mm, and a scanning speed of 20 mm/s to 150 mm/s.

Preferably, in the step B, the carbon precursor material is selected from the group consisting of a cyanate ester resin, a polytriazine polymer, and a conjugated triazine polymer; and a thickness of the carbon precursor material is 40 μm to 150 μm.

Preferably, the flexible sheet material is selected from the group consisting of polyimide (PI), polyethylene terephthalate (PET), polyetherimide (PEI), polyethylene naphthalate (PEN), and MXene; a form of the flexible sheet material is selected from the group consisting of a flexible film material and a flexible paper-based material; and a thickness of the flexible sheet material is 30 μm to 150 μm.

Preferably, when the flexible sheet material is the flexible film material, the pre-treatment in the step A is hydrophilic treatment; a resulting pre-treated flexible sheet material has a contact angle of less than 90°; and the hydrophilic treatment is selected from the group consisting of oxidation treatment, plasma treatment, surfactant coating, and laser engraving modification.

Preferably, when the hydrophilic treatment is the laser engraving modification, the step A includes the following sub-steps:
placing the flexible sheet material at a focal position, and conducting grid patterning on the flexible sheet material with laser to complete the hydrophilic treatment; where the laser has a wavelength of 200 nm to 360 nm, a pulse width less than 12 ps, a laser power of 6 W to 8 W, a laser scanning speed of 600 mm/s to 900 mm/s, and a scanning spacing of 60 μm to 100 μm.

Preferably, in the step B, the coating the carbon precursor material onto the flexible sheet substrate includes: attaching a mask to the flexible sheet substrate, where the mask is provided with an opening not smaller than a pre-treated area, the opening corresponds to the pre-treated area, and a thickness of the mask is identical to the required thickness of the solid carbon precursor; and coating the carbon precursor material onto the pre-treated area, and scraping off an excess carbon precursor material to control the thickness of the carbon precursor material; where the opening of the mask is obtained through one selected from the group consisting of physical cutting, photolithography, etching, and laser processing.

Preferably, when the flexible sheet material is the flexible paper-based material, the pre-treatment in the step A is selected from the group consisting of immersion, coating, and spin coating.

Preferably, in the step B, the coating the carbon precursor material onto the flexible sheet substrate includes: completely dissolving the carbon precursor material in a solvent to obtain a carbon precursor solution; and spin-coating the carbon precursor solution onto the flexible sheet substrate to the required thickness using a spin coater.

Preferably, in the step C, an atmosphere for the laser is selected from the group consisting of an air atmosphere, an inert gas protective atmosphere, an oxygen and inert gas mixture environment, and a vacuum environment.

The technical solutions provided by the present disclosure may have the following beneficial effects:
A carbon precursor material with a triazine ring network cross-linking structure is loaded onto a high-temperature-resistant flexible sheet material, and direct-writing scanning is conducted with specific laser parameters. Graphene is formed while corresponding micro-scale/nano-scale structures are simultaneously created. This enables high-precision processing and three-dimensional structuring of the graphene film with a straightforward process. Furthermore, by defining the range of laser parameters, a high-quality graphene film with a micrometer groove array and a triangular cross-section can be obtained within this range. Meanwhile, the laser parameters adjusted within this range can correspondingly regulate the dimensions of the micro-scale/nano-scale structures. Therefore, the performance of the device can be tuned, resulting in high controllability.

### BRIEF DESCRIPTION OF THE DRAWINGS

FIG. 1 shows a scanning electron microscope (SEM) cross-sectional image of Example 1 of the present disclosure;

FIG. 2 shows a laser confocal microscopy image of Example 1 of the present disclosure;

FIG. 3 shows an SEM cross-sectional image of Comparative Example 1 of the present disclosure;

FIG. 4 shows a laser confocal microscopy image of Comparative Example 2 of the present disclosure;

FIG. 5 shows a volt-ampere curve of the capacitor corresponding to Example 1 of the present disclosure;

FIG. 6 shows a volt-ampere curve of the capacitor corresponding to Comparative Example 1 of the present disclosure; and

FIG. 7 is a flow chart showing a method for preparing a graphene film with a micrometer groove array and a triangular cross-section according to an embodiment of the present disclosure.

### DETAILED DESCRIPTION OF THE EMBODIMENTS

The technical solutions of the present disclosure will be further described below through specific embodiments.

To facilitate the understanding of the present disclosure, the present disclosure will be described comprehensively below. The present disclosure can be implemented in many different forms and is not limited to the examples described herein. On the contrary, these examples are provided such that the disclosure of the present disclosure can be understood thoroughly and comprehensively.

If specific techniques or conditions are not indicated in an example, a process is conducted in accordance with the techniques or conditions described in literatures in the prior art or in accordance with a product specification. All of the used reagents or instruments which are not specified with manufacturers are conventional commercially-available products.

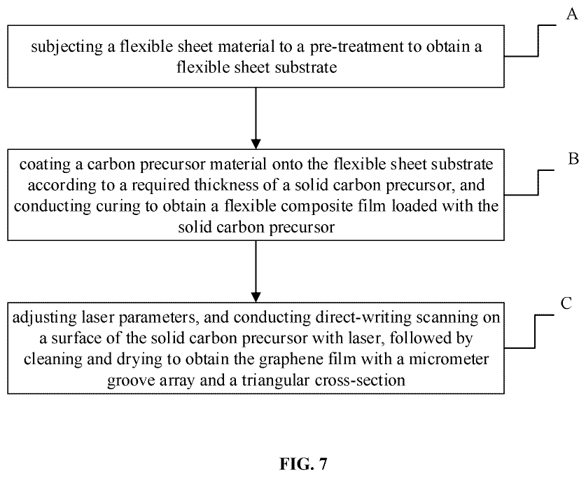

As shown in FIG. 7, the present disclosure provides a method for preparing a graphene film with a micrometer groove array and a triangular cross-section, including the following steps:
A, subjecting a flexible sheet material to a pre-treatment, and obtaining a flexible sheet substrate;
B, coating a carbon precursor material onto the flexible sheet substrate according to a required thickness of a solid carbon precursor, and conducting curing to obtain a flexible composite film loaded with the solid carbon precursor; where the carbon precursor material has a triazine ring network cross-linking structure; and
C, adjusting laser parameters, and conducting direct-writing scanning on a surface of the solid carbon precursor with laser, followed by cleaning and drying to obtain the graphene film with a micrometer groove array and a triangular cross-section.

With the continuous development of electronic devices towards miniaturization and high performance, graphene films with higher effective specific surface area and periodic array structures are required to meet the demands of corresponding flexible devices. However, traditional processing techniques face difficulties in controlling the quality of graphene films, involve high costs, and have relatively complex processes, failing to meet the requirements for high precision and three-dimensional structuring of graphene films at the micro-scale/nano-scale scale. Moreover, when the electrical, mechanical, and chemical characteristics of the devices need to be altered, templates must be recreated, resulting in low controllability and high costs.

To address these issues, the present disclosure proposes a method for preparing a graphene film with a micrometer groove array and a triangular cross-section. This preparing method employs an ultraviolet ultrafast laser to conduct direct-writing scanning on a solid carbon precursor loaded on a flexible composite film, thereby fulfilling the requirements for high precision and three-dimensional micro-scale/nano-scale structuring of the graphene film. With laser for direct-writing scanning is an efficient, low-cost, and high-precision micro-scale/nano-scale processing technique for material synthesis and transformation. It offers rapid processing capabilities with high efficiency and fine detail, along with broad material compatibility and a wide processing range. Furthermore, due to the non-contact nature and high-speed operation of ultraviolet ultrafast laser direct-writing scanning, the complex procedures involved in mask preparation in traditional lithography techniques are effectively avoided. By adjusting specific laser parameters, various micro-scale/nano-scale structures of the graphene film can be efficiently fabricated, achieving three-dimensional structuring and enabling macro-level control over the quality of graphene.

Simultaneously, the carbon precursor material used in the present disclosure forms a triazine ring network cross-linking structure after curing. The triazine ring network cross-linking polymer forms a highly cross-linking structure through multi-point covalent bonds, endowing the carbon precursor with this structure with excellent mechanical properties, thermal stability, and chemical tolerance. This effectively controls heat diffusion in the laser-irradiated area during ultraviolet ultrafast laser scanning, preventing large-area combustion and dimensional expansion during laser processing. It ensures high processing precision while minimizing thermal deformation and surface damage. Additionally, the highly cross-linking nature of this structure results in a relatively smooth surface after laser processing, allowing the formed micro-scale/nano-scale structures to maintain their shape promptly after laser removal. Furthermore, direct-writing scanning with a laser on the flexible composite film loaded with the solid carbon precursor enables direct synthesis of graphene. The focused laser beam can generate extremely high temperatures on the target material, which are sufficient to break chemical bonds and prompt carbon atoms to rearrange into graphene. Processing according to the steps A to C involves pre-treatment on the flexible sheet material to obtain a flexible sheet substrate, which facilitates the coating of the carbon precursor material in the step B. After coating and curing the carbon precursor material, a flexible composite film loaded with the solid carbon precursor is obtained. Under specific laser parameters, the laser can simultaneously induce the formation of graphene on the surface of the solid carbon precursor and create regular micro-scale/nano-scale groove structures. This allows for high-precision control over the morphology and dimensions of the micro-scale/nano-scale groove structures by adjusting the laser parameters. The resulting graphene exhibits high quality and excellent electrical conductivity, making it suitable for preparing micro-advanced devices such as capacitors and sensors. This addresses the challenges of current traditional processing techniques, which struggle to achieve high precision and three-dimensional micro-scale/nano-scale structures in graphene films, cannot control the morphology and dimensions of micro-scale/nano-scale structures, and face difficulties in quality control.

Preferably, in the step B, the curing should be implemented according to different temperature programs based on the inherent characteristics of various carbon precursor materials, enabling the cured carbon precursor material to transform from monomers into a highly cross-linking solid polymer, uniformly loaded on the flexible film substrate.

Preferably, in the step C, the laser parameters include: a wavelength of 200 nm to 360 nm, a pulse width less than 12 ps, a laser power of 3 W to 5 W, and conducting unidirectional overlapping linear scanning with laser in a defocusing manner; and the unidirectional overlapping linear scanning with laser has a scanning spacing of 20% to 60% of a spot size, a defocusing amount of −2 mm to −8 mm, and a scanning speed of 20 mm/s to 150 mm/s.

The graphene film with a micrometer groove array and a triangular cross-section can enhance charge transport, reduce charge accumulation and local supersaturation, improve electrochemical reaction performance, and increase mechanical stability. This structured graphene film requires processing of the solid carbon precursor with laser under specific laser parameters to form. Defining the laser parameters ensures full superposition and combined action of the Gaussian effect of the laser and the Marangoni effect of the molten carbon precursor resin, guaranteeing both the conversion of the resin into high-quality graphene and the construction of the micro-scale/nano-scale scale structure of the graphene, thereby forming a groove array-shaped graphene film and a triangular cross-section. Specifically, on one hand, there is the Gaussian effect of the laser: the intensity distribution of the laser beam follows a Gaussian distribution. The energy density is highest in the central region of the laser beam and gradually decreases with increasing distance from the center. During linear scanning, this energy distribution causes different areas of the material surface to be heated to varying degrees. The concentrated energy in the central part leads to excessive ablation of graphene, forming a groove-like array on the material surface, where the lowest part of the groove corresponds to the region of the highest laser energy. On the other hand, the influence of the Marangoni effect: the Marangoni effect refers to the flow phenomenon within a liquid due to uneven surface tension distribution under a temperature gradient. When the laser beam irradiates the carbon precursor material, the high energy input causes the material to rapidly heat up and transition into a high-temperature molten state. In this state, the fluidity of the material significantly increases, and the Marangoni effect comes into play. Because the energy density is highest at the center of the laser beam, a molten carbon material formed in the central region flows towards the two sides with lower energy due to differences in surface tension. This causes the molten carbon material to accumulate on both sides of the laser beam path, ultimately forming a micro-scale/nano-scale structure with a triangular cross-section. Through the synergistic action of the Gaussian effect and the Marangoni effect of the laser, a carbonized layer is formed on the upper surface of the solid carbon precursor, while the uncarbonized carbon precursor in the lower layers is also affected by the laser, causing flow. The upper and lower layers together form a composite micro-scale/nano-scale structure, meaning the laser can prepare graphene films with fine micro-scale/nano-scale structures. More specifically, it can form the graphene film with a micrometer groove array and a triangular cross-section.

Herein, defining the wavelength as 200 nm to 360 nm and the pulse width as less than 12 ps ensures the absorption rate of the carbon precursor material to the laser, meaning it can more effectively absorb laser energy, thereby improving processing efficiency and quality. Simultaneously, a pulse width less than 12 ps, being short, can generate high energy density on the surface of the carbon precursor, ensuring the precision of laser processing and meeting the requirements of micro-scale/nano-scale structures. Limiting the laser power to 3 W to 5 W matches the performance of the carbon precursor with the triazine ring network cross-linking structure, avoiding damage to surface structures such as phase explosion. Within the defined scanning speed range, the corresponding laser power can meet the conditions for generating high-quality graphene, fulfill quality control requirements, and reduce occurrences of insufficient coverage and poor regularity of microstructure morphology. Regarding the defocusing amount, if it is too small, the spot size during laser scanning becomes too small, leading to highly concentrated energy and prone to over-ablation or over-etching. If the defocusing amount is too high, it disperses the laser energy, making it difficult to form the groove array structure. Therefore, limiting the defocusing amount to −2 mm to −8 mm ensures the groove structure of the graphene film can form and be regular. Furthermore, for the linear scanning spacing, if it is too narrow, the laser irradiation becomes too dense, easily causing over-ablation. If the linear scanning spacing is too wide, the graphitized coverage area becomes incomplete, failing to form the required micro-scale/nano-scale structure. Hence, the scanning spacing for the unidirectional overlapping linear scanning with laser is defined as 20% to 60% of the spot size. For example, in one embodiment, the spot size is 80 μm, and the scanning spacing is hence 16 μm to 47 μm. This ensures the cross-sectional morphology and height difference fall within the required range, i.e., forming a regular triangular cross-section, preventing transformation, damage, and disorder of the micro-scale/nano-scale structures, and guaranteeing the quality of the obtained graphene film.

Preferably, the micrometer groove array with a triangular cross-section in the graphene film has a height difference of 10 μm to 50 μm and an aspect ratio of 0.2 to 1.5. Exceeding this range may lead to issues such as poor graphene quality, incomplete graphene coverage, excessive ablation, and structural disorder. Within the defined laser parameter range, particularly the defocusing amount, scanning spacing, and laser power, it is possible to adjust the size, spacing, and height difference of the triangular groove array according to requirements without exceeding the specified range of height difference and aspect ratio. Consequently, the electrical, mechanical, and chemical characteristics of the device can be tuned, providing flexibility for performance optimization of energy storage devices and sensors. Specifically, under single-factor variation conditions, the scanning spacing during the laser linear overlapping scanning process primarily has a significant impact on the base length and height of the triangle in the cross-section. The change in laser power represents a change in laser energy density; fine-tuning the laser energy density can regulate the increase or decrease in the height difference of the groove array structure. For example, an increase in laser power leads to a greater height difference of the grooves. Adjustments can be made as needed, offering high controllability without the need to recreate templates, thereby reducing costs.

Preferably, in the step B, the carbon precursor material is selected from the group consisting of a cyanate ester resin, a polytriazine polymer, and a conjugated triazine polymer; and a thickness of the carbon precursor material is 40 μm to 150 μm.

In terms of graphene formation, different carbon precursor materials result in variations in graphene thickness, quality, and formation conditions. The carbon precursor material, after curing, forms a triazine ring network cross-linking structure, specifically being one of cyanate ester resin, polytriazine polymer, and conjugated triazine polymer. This ensures that the produced graphene film has a regular array structure, is well-ordered and not prone to disorder, and possesses high structural stability, laying the foundation for laser processing. It guarantees that the corresponding structure can be adjusted by regulating the laser parameters to obtain the desired performance.

Specifically, a thickness of the carbon precursor material is 40 μm to 150 μm, ensuring the formation effectiveness of the graphene structure during laser processing and avoiding excessive ablation or disorder in the micro-scale/nano-scale structure.

Preferably, the carbon precursor material is cyanate ester resin. Cyanate ester resin offers desirable thermal stability and electrical conductivity, adjustable specific surface area and pore structure, high compatibility with graphene, and excellent structural formation stability. This is conducive to forming graphene films with the corresponding structure.

Preferably, the flexible sheet material is selected from the group consisting of polyimide (PI), polyethylene terephthalate (PET), polyetherimide (PEI), polyethylene naphthalate (PEN), and MXene; a form of the flexible sheet material is selected from the group consisting of a flexible film material and a flexible paper-based material; and a thickness of the flexible sheet material is 30 μm to 150 μm.

Specifically, the flexible sheet material is one of PI, PET, PEI, PEN, and MXene. These flexible sheet materials all exhibit excellent heat resistance, mechanical properties, and chemical stability, which are beneficial for maintaining dimensional stability during processing.

Simultaneously, the flexible sheet material serving as a substrate acts as a flexible support, not affecting the subsequent preparation of flexible devices. The thickness of the flexible sheet material is 30 μm to 150 μm, ensuring both flexibility and avoidance of excessively high costs. It is compatible with the laser scanning processing technique, preventing damage due to penetration by the laser or warping caused by thermal stress concentration.

Further, when the flexible sheet material is the flexible film material, the pre-treatment in the step A is hydrophilic treatment; a resulting pre-treated flexible sheet material has a contact angle of less than 90°; and
the hydrophilic treatment is selected from the group consisting of oxidation treatment, plasma treatment, surfactant coating, and laser engraving modification.

Specifically, for the flexible film material, the pre-treatment is hydrophilic treatment aimed at creating a hydrophilic area to facilitate the subsequent loading of the carbon precursor material. The hydrophilic treatment makes the material surface more easily wetted by water, with a contact angle of less than 90°, allowing the carbon precursor material to wet the flexible film material effectively later on.

Additionally, the hydrophilic treatment is one of oxidation treatment, plasma treatment, surfactant coating, and laser engraving modification. These methods improve the hydrophilicity of the flexible film material without significantly affecting its mechanical properties, ensuring subsequent operations proceed normally. They also help guarantee that the obtained graphene film with a micrometer groove array and a triangular cross-section exhibits desirable stability and durability, which are beneficial for the subsequent preparation of flexible electronic devices.

Preferably, when the hydrophilic treatment is the laser engraving modification, the step A includes the following sub-steps:
placing the flexible sheet material at a focal position, and conducting grid patterning on the flexible sheet material with laser to complete the hydrophilic treatment; where the laser has a wavelength of 200 nm to 360 nm, a pulse width less than 12 ps, a laser power of 6 W to 8 W, a laser scanning speed of 600 mm/s to 900 mm/s, and a scanning spacing of 60 μm to 100 μm.

Specifically, the aforementioned operations and corresponding parameters ensure the completion of the hydrophilic treatment, namely the laser-based modification. The flexible sheet material is placed at the focal position to ensure that the laser beam conducts patterning at its smallest spot size, preventing excessive ablation. The defined laser parameters guarantee a sufficiently high absorption rate of the laser by the PI, enabling effective completion of the subsequent grid patterning operation. Meanwhile, the defined scanning spacing ensures the patterned area achieves optimal hydrophilic performance after the laser treatment.

Preferably, in the step B, the coating the carbon precursor material onto the flexible sheet substrate includes: attaching a mask to the flexible sheet substrate, where the mask is provided with an opening not smaller than a pre-treated area, the opening corresponds to the pre-treated area, and a thickness of the mask is identical to the required thickness of the solid carbon precursor; and coating the carbon precursor material onto the pre-treated area, and scraping off an excess carbon precursor material to control the thickness of the carbon precursor material; where the opening of the mask is obtained through one selected from the group consisting of physical cutting, photolithography, etching, and laser processing.

Specifically, the mask with the opening is closely attached to the flexible sheet substrate. The opening corresponds to and is not smaller than the pre-treated area. The mask and the flexible sheet substrate together form a miniature container with an opening, which is then filled with the carbon precursor material. The mask has a thickness of 60 μm to 150 μm, which is identical to the required thickness of the solid carbon precursor, thereby achieving control over its thickness.

Preferably, both the length and width of the opening of the mask are 1 mm to 3 mm larger than those of the pre-treated area.

Preferably, the shape of the mask's opening is matched with the pre-treated area and can be rectangular, triangular, or diamond-shaped.

Preferably, when the flexible sheet material is the flexible paper-based material, the pre-treatment in the step A is selected from the group consisting of immersion, coating, and spin coating.

Specifically, the flexible paper-based material itself is porous and loose, allowing it to absorb the carbon precursor material. Using immersion, coating, or spin coating results in a flexible paper-based material that uniformly absorbs the carbon precursor material. This facilitates the subsequent loading of more carbon precursor material onto its surface, preventing difficulties in coating the carbon precursor material onto the flexible sheet substrate in the step B due to absorption by the paper-based material. It also prevents disordered surface structure during the subsequent laser processing, which could affect the preparation of the micro-scale/nano-scale groove structures.

Preferably, the pre-treatment is immersion. Cyanate ester resin is selected as the carbon precursor material and then uniformly dissolved in a solvent, where the cyanate ester resin and the solvent are at a volume ratio of 1:2, and obtaining a carbon precursor solution. The flexible paper-based material is pre-treated using immersion by soaking it in the carbon precursor solution for 10 min to 30 min. A minimum of 10 min ensures the carbon precursor solution fully infiltrates the flexible paper-based material. The carbon precursor solution must be consistent with the carbon precursor material to be coated subsequently, meeting the material requirement of possessing a triazine ring network cross-linking structure after curing. The material is then removed and dried at 50° C. to 80° C. for 30 min to 60 min to remove the solvent, completing the pre-treatment. The solvent can be an organic solvent such as acetone, toluene, or butanone, which is used to adjust the viscosity and fluidity of the resin.

Preferably, in the step B, the coating the carbon precursor material onto the flexible sheet substrate includes: completely dissolving the carbon precursor material in a solvent to obtain a carbon precursor solution; and spin-coating the carbon precursor solution onto the flexible sheet substrate to the required thickness using a spin coater.

Specifically, a solvent is selected that can effectively dissolve the carbon precursor material without reacting with it, and that can volatilize upon heating to avoid introducing other components during processing. After the pre-treatment in the step A, where the flexible paper-based material absorbs a sufficient amount of the carbon precursor material, forming a flexible sheet substrate conducive to loading. The step B further requires loading the carbon precursor onto its surface by spin-coating. A spin coater is used to uniformly spin-coat the carbon precursor solution onto the flexible sheet substrate, thereby achieving control over the thickness of the carbon precursor.

Preferably, the spin-coating is conducted within 15 s to 40 s at a spin-coating speed of 1,500 rpm to 4,000 rpm, where the number of spin-coating passes is not less than 3, thereby defining the final spin-coated thickness within the range of 60 μm to 150 μm.

Preferably, in the step C, an atmosphere for the laser is selected from the group consisting of an air atmosphere, an inert gas protective atmosphere, an oxygen and inert gas mixture environment, and a vacuum environment.

Specifically, defining the atmosphere ensures that no unrelated chemical reactions occur during the graphene formation and guarantees the quality of the graphene.

The technical solutions of the present disclosure will be further described below through specific embodiments.

### Example 1

In step A, a PI film is tightly attached to a glass sheet with dimensions of 120 mm×60 mm×3 mm. The portion of the PI film exceeding the size of the carrier glass sheet is trimmed off, and the PI film is repeatedly pressed firmly using an acrylic rod. After cleaning and drying, a 355 nm, 10 ps UV picosecond laser is used to conduct grid patterning for hydrophilic treatment, resulting in a flexible sheet substrate. The laser engraving has a defocusing amount of 0 mm, a laser power of 8 W, and a scanning speed of 800 mm/s. The designed grid pattern is a 50 mm×40 mm rectangle with a grid spacing of 64 μm. The thickness of the PI film is 120 μm.

In step B, a commercially available solid PI film is selected as the mask. A 355 nm, 10 ps UV picosecond laser is used to engrave a 100 mm×40 mm rectangular opening on the 120 mm×60 mm PI film, matching the size of the hydrophilic-treated grid pattern from step A. The mask is tightly attached to the PI film and repeatedly pressed and secured using tweezers and a small acrylic rod. Commercially available cyanate ester resin is selected as the carbon precursor material, heated to 120° C. on a hot plate, coated onto the mask opening area (i.e., the hydrophilic-treated area), and a coating rod is used to scrape off the excess cyanate ester resin above the mask. The resin is then cured, resulting in a flexible composite film loaded with the solid carbon precursor. The laser engraving has a defocusing amount of 0 mm, a laser power of 7 W, and a scanning speed of 60 mm/s. The thickness of the mask is 120 μm, and the dimensions of the solid carbon precursor (solid cyanate ester resin) are 100 mm×40 mm×0.12 mm.

In step C, a UV picosecond laser is used to conduct unidirectional overlapping linear scanning on the surface of the solid carbon precursor of the flexible composite film in a defocused manner. The film is then cleaned using deionized water, dried on a constant-temperature hot plate, and peeled off from the carrier glass sheet to obtain the graphene film with a micrometer groove array and a triangular cross-section. The laser parameters include: a wavelength of 355 nm, a pulse width of 10 ps, a laser power of 4 W, a defocusing amount of −2.8 mm, a scanning speed of 100 mm/s, and a scanning spacing of 32 μm for the unidirectional overlapping linear scanning.

### COMPARATIVE EXAMPLES

### Comparative Example 1

Compared with Example 1, Comparative Example 1 directly uses a PI film as the carbon precursor.

In step A, a PI film is tightly attached to a glass sheet with dimensions of 120 mm×60 mm×3 mm. The portion of the PI film exceeding the size of the carrier glass sheet is trimmed off, and the PI film is repeatedly pressed firmly using an acrylic rod. The assembly is then cleaned and dried.

In step B, a UV picosecond laser is used to conduct unidirectional overlapping linear scanning on the surface of the solid carbon precursor of the flexible composite film in a defocused manner. The film is then cleaned using deionized water, dried on a constant-temperature hot plate, and peeled off from the carrier glass sheet to obtain a graphene film. The laser parameters include: a wavelength of 355 nm, a pulse width of 10 ps, a laser power of 4 W, a defocusing amount of −9 mm, a scanning speed of 100 mm/s, and a scanning spacing of 26 μm for the unidirectional overlapping linear scanning.

### Comparative Example 2

Compared with Example 1, the distinction in Comparative Example 2 lies in step C, where the scanning spacing for the unidirectional overlapping linear scanning of the laser is 82 μm.

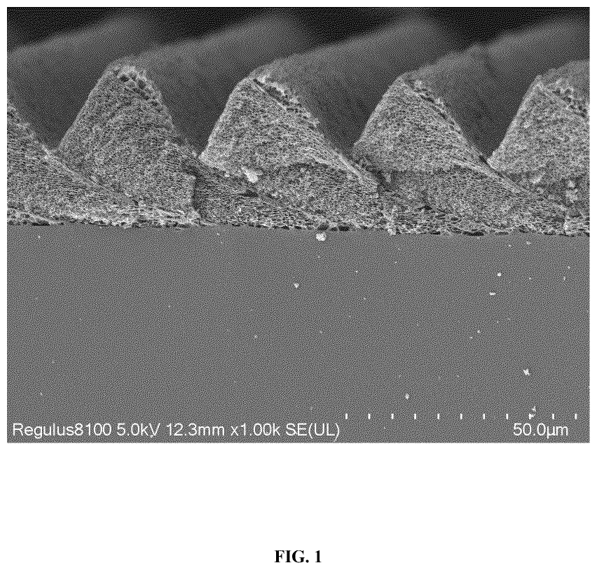

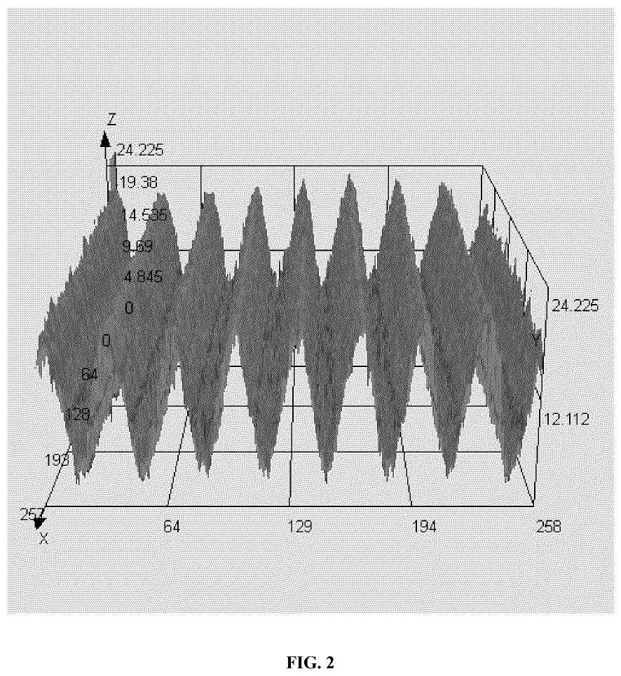

The SEM cross-sectional image of the graphene film obtained in Example 1 is shown in FIG. 1, and its image under a laser confocal microscope is shown in FIG. 2. It can be seen from the figures that the graphene film obtained in Example 1 exhibits a distinct triangular cross-section at the micrometer scale, with a regular and orderly groove array.

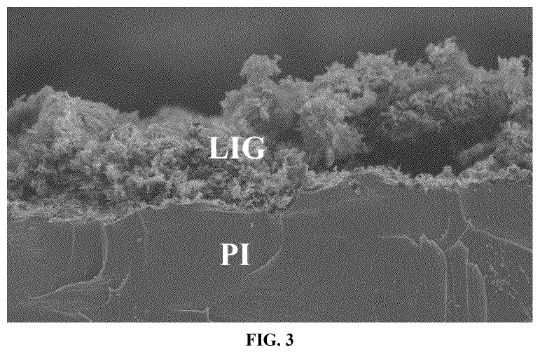

Compared with Example 1, Comparative Example 1 uses a different carbon precursor material. The SEM image of the graphene film from Comparative Example 1 is shown in FIG. 3. It can be observed that the upper layer consists of laser-induced graphene (LIG) while the lower layer is PI. This graphene film lacks a uniform structure, shows an indistinct array pattern, and specifically presents as a porous graphene with disordered micro-scale/nano-scale structures. It does not possess a regular groove array, let alone a triangular cross-section.

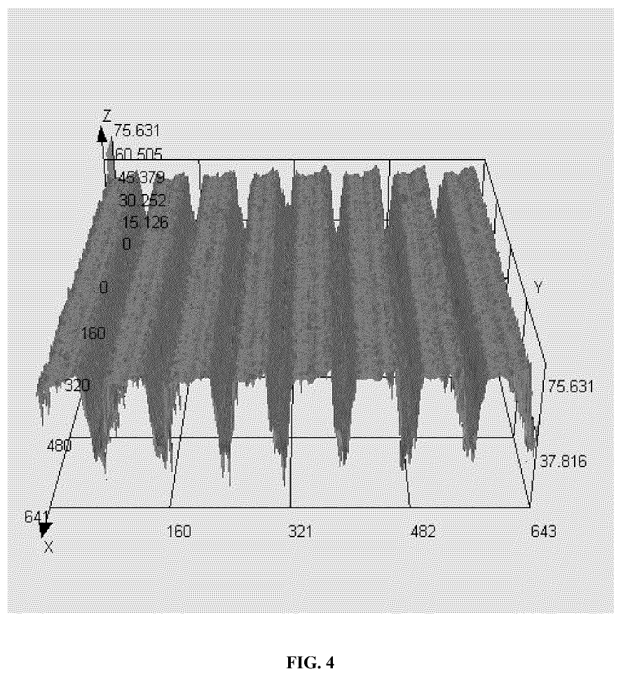

In Comparative Example 2, during laser processing, the scanning spacing exceeds the range defined in the present disclosure. The laser confocal microscopy image of the graphene film obtained in Comparative Example 2 is shown in FIG. 4. It can be seen that the three-dimensional profile of the graphene film no longer exhibits a triangular cross-section but instead shows array grooves resulting from multiple laser linear scanning ablations. Furthermore, the generated graphene film has low thickness and poor electrical conductivity.

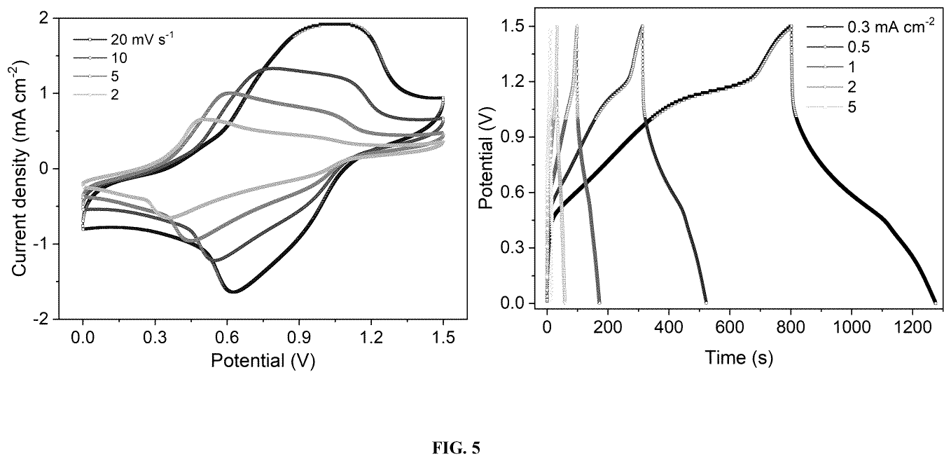

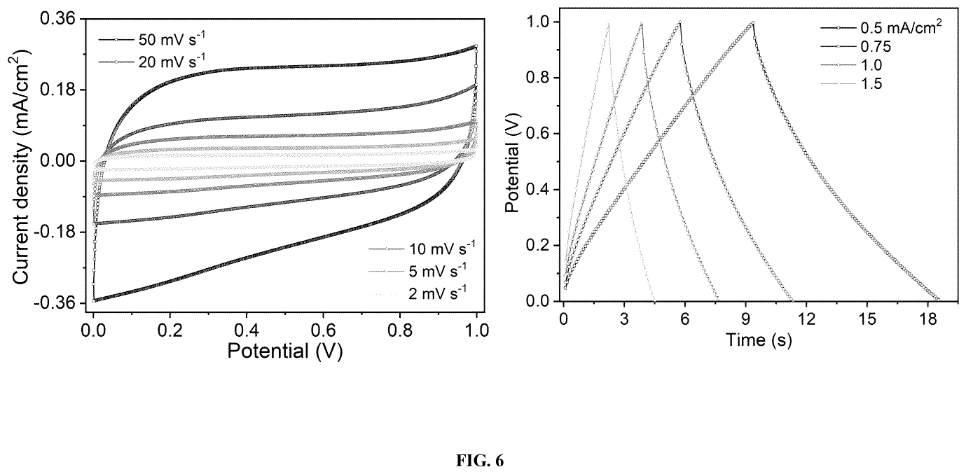

The graphene films obtained from Example 1 and Comparative Example 1 are used to prepare capacitors, respectively, and the prepared capacitors are tested. FIG. 5 shows the volt-ampere curve of the capacitor made from the graphene film of Example 1, while FIG. 6 shows the volt-ampere curve of the capacitor made from the graphene film of Comparative Example 1. The results indicate that at the same current density, the capacitor from Example 1 has a longer charge-discharge time and a higher areal capacitance value, reaching 94.8 mF/cm².

The technical principles of the present disclosure are described above with reference to the specific embodiments. These descriptions are merely intended to explain the principles of the present disclosure, and may not be construed as limiting the protection scope of the present disclosure in any way. Based on the explanation herein, those skilled in the art may derive other specific implementations of the present disclosure without creative effort, but these implementations should fall within the protection scope of the present disclosure.

What is claimed is:

1. A method for preparing a graphene film with a micrometer groove array and a triangular cross-section, comprising following steps:
A, subjecting a flexible sheet material to a pre-treatment to obtain a flexible sheet substrate;
B, coating a carbon precursor material onto the flexible sheet substrate according to a required thickness of a solid carbon precursor, and conducting curing to obtain a flexible composite film loaded with the solid carbon precursor; wherein
the carbon precursor material has a triazine ring network cross-linking structure; and
C, adjusting laser parameters, and conducting direct-writing scanning on a surface of the solid carbon precursor with laser, followed by cleaning and drying to obtain the graphene film with a micrometer groove array and a triangular cross-section.

2. The method according to claim 1, wherein in the step C, the laser parameters comprise: a wavelength of 200 nm to 360 nm, a pulse width less than 12 ps, a laser power of 3 W to 5 W, and conducting unidirectional overlapping linear scanning with laser in a defocusing manner; and
the unidirectional overlapping linear scanning with laser has a scanning spacing of 20% to 60% of a spot size, a defocusing amount of −2 mm to −8 mm, and a scanning speed of 20 mm/s to 150 mm/s.

3. The method according to claim 1, wherein in the step B, the carbon precursor material is selected from the group consisting of a cyanate ester resin, a polytriazine polymer, and a conjugated triazine polymer; and
a thickness of the carbon precursor material is 40 μm to 150 μm.

4. The method according to claim 1, wherein the flexible sheet material is selected from the group consisting of polyimide (PI), polyethylene terephthalate (PET), polyetherimide (PEI), polyethylene naphthalate (PEN), and MXene; a form of the flexible sheet material is selected from the group consisting of a flexible film material and a flexible paper-based material; and
a thickness of the flexible sheet material is 30 μm to 150 μm.

5. The method according to claim 4, wherein in response to that the flexible sheet material is the flexible film material, the pre-treatment in the step A is hydrophilic treatment; a resulting pre-treated flexible sheet material has a contact angle of less than 90°; and
the hydrophilic treatment is selected from the group consisting of oxidation treatment, plasma treatment, surfactant coating, and laser engraving modification.

6. The method according to claim 5, wherein in response to that the hydrophilic treatment is the laser engraving modification, the step A comprises following sub-steps:
placing the flexible sheet material at a focal position, and conducting grid patterning on the flexible sheet material with laser to complete the hydrophilic treatment; wherein
the laser has a wavelength of 200 nm to 360 nm, a pulse width less than 12 ps, a laser power of 6 W to 8 W, a laser scanning speed of 600 mm/s to 900 mm/s, and a scanning spacing of 60 μm to 100 μm.

7. The method according to claim 5, wherein in the step B, the coating the carbon precursor material onto the flexible sheet substrate comprises:
attaching a mask to the flexible sheet substrate, wherein the mask is provided with an opening not smaller than a pre-treated area, the opening corresponds to the pre-treated area, and a thickness of the mask is identical to the required thickness of the solid carbon precursor; and
coating the carbon precursor material onto the pre-treated area, and scraping off an excess carbon precursor material to control the thickness of the carbon precursor material; wherein
the opening of the mask is obtained through one selected from the group consisting of physical cutting, photolithography, etching, and laser processing.

8. The method according to claim 4, wherein in response to that the flexible sheet material is the flexible paper-based material, the pre-treatment in the step A is selected from the group consisting of immersion, coating, and spin coating.

9. The method according to claim 8, wherein in the step B, the coating the carbon precursor material onto the flexible sheet substrate comprises:
completely dissolving the carbon precursor material in a solvent to obtain a carbon precursor solution; and
spin-coating the carbon precursor solution onto the flexible sheet substrate to the required thickness of the solid carbon precursor using a spin coater.

10. The method according to claim 1, wherein in the step C, an atmosphere for the laser is selected from the group consisting of an air atmosphere, an inert gas protective atmosphere, an oxygen and inert gas mixture environment, and a vacuum environment.
